(19) United States
(12) Patent Application Publication
(10) Pub. No.: US 2006/0126466 A1
(43) Pub. Date: Jun. 15, 2006

(54) Information recording apparatus, information reproducing apparatus, information recording method, and information reproducing method with an improved track jump performance

(76) Inventors: Seiji Imagawa, Yokohama (JP); Koichiro Nishimura, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/299,669

(22) Filed: Dec. 13, 2005

(30) Foreign Application Priority Data
Dec. 15, 2004 (JP) 2004-362184

(51) Int. Cl. G11B 5/09

(52) U.S. Cl. 369/47.36; 369/44.28

(57) ABSTRACT

An optical disc reproducing apparatus and an optical disc recording apparatus for reproducing an optical disc. The apparatus includes an optical pickup unit for irradiating a laser beam to the optical disc, an optical pickup drive unit for moving the optical pickup in the radial direction of the optical disc, and a motor unit for rotating the optical disc. When a tracking jump command is issued, the optical pickup drive unit moves the optical pickup unit in the radial direction of the optical disc at the timing in accordance with the rotation speed of the optical disc after the laser beam irradiated to the optical disc has passed the address information recording portion indicating the address of the optical disc.

### INCORPORATION BY REFERENCE

The present application claims priority from Japanese application JP 2004-362184 filed on Dec. 15, 2004, the content of which is hereby incorporated by reference into this application.

### BACKGROUND OF THE INVENTION

The present invention relates to an information recording apparatus, an information reproducing apparatus, an information recording method, and an information reproducing method and in particular to an optical disc recording apparatus, a reproducing apparatus, a recording method, and a reproducing method with an improved track jump performance.

Conventionally, there has been suggested a tracking jump control apparatus for storing a scan position of a scanner where a tracking jump error has occurred in the information recording medium and outputting a tracking jump instruction at a timing when the track jump is not overlapped with the scan position of the scanner stored. For example, see JP-A-05-205287.

### SUMMARY OF THE INVENTION

In the aforementioned conventional technique, starting a tracking jump at a timing in accordance with the rotation speed of a disc is not performed and no correction of a tracking error signal used for controlling the tracking jump is performed. Accordingly, there arises a problem of control of a tracking jump in, in particular, a high rotation speed of an optical disc.

That is, in an optical disc drive, a tracking error signal is used to control the tracking jump for moving the focal spot to an adjacent track. As shown in FIG. 1, the waveform of the tracking error signal changes in accordance with the movement of the focal spot between the tracks. In control of the tracking jump, the timing when the focal spot crosses the boundary between tracks (zero-cross timing) is especially important because at the zero-cross timing 1, the acceleration voltage is switched to a deceleration voltage and at the zero-cross timing 2, application of the deceleration voltage is terminated and mode is switched to the normal feedback control, thereby realizing the tracking jump.

However, in the DVD-RAM discs, there is a case that it is impossible to accurately detect the zero-cross timing. This is because in the DVD-RAM discs, a physical identifier (PID) indicating disc address information is provided as a physical pit and when the focal spot cross the physical identifier in the tracking jump operation, the tracking error signal changes to a false signal and it becomes impossible to grasp the accurate positional relationship between the focal spot and the track. Especially as shown in FIG. 2, when the physical identifier is crossed at the zero-cross timing, it may become impossible to obtain a correct voltage control switching timing and the tracking jump may fail or the disc reproducing operation or recording operation may fail.

In order to solve this problem, it is possible to control the start timing so that the tracking jump operation may be started immediately after the focal spot has crossed the physical identifier and the tracking jump operation terminates until the next physical identifier is crossed. However, when the recording speed or the reproduction speed increases, there arises a problem that even if the tracking jump operation is started immediately after the physical identifier is crossed, the tracking jump operation may not be completed before the next physical identifier is crossed. The time required for a tracking jump is about 200 μs to 300 μs while the time between a crossing of a physical identifier and a crossing of the next physical identifier is about 500 μm at the 3×-speed and about 300 μs at 5×-speed. At the recording speed or reproduction speed exceeding 5×-speed, a physical identifier is inevitably crossed during a tracking jump. That is, as shown in FIG. 2, the tracking error signal changes into a false signal and it becomes impossible to grasp an accurate positional relationship between the focal spot and the track. Finally, the track jump may fail or the disc reproduction operation or recording operation may fail.

It is therefore an object of the present invention to provide an information recording apparatus, an information reproducing apparatus, an information recording method, and an information reproducing method having a high reliability.

In order to achieve the aforementioned object, according to an aspect of the present invention, an optical disc reproducing apparatus for reproducing information from an optical disc comprises: an optical pickup unit for irradiating a laser beam onto the optical disc, an optical pickup drive unit for moving the optical pickup unit in the radial direction of the optical disc, and a motor unit for rotating the optical disc, wherein after the laser beam irradiated to the optical disc crosses the address information recording portion indicating the address of the optical disc, the optical pickup drive unit moves the optical pickup unit in the radial direction of the optical disc at the timing corresponding to the rotation speed of the optical disc.

Moreover, according to another aspect of the present invention, an optical disc reproducing apparatus for reproducing information from an optical disc comprises: an optical pickup unit for irradiating a laser beam to the optical disc, a signal generation unit for generating a tracking error signal indicating the relative position between the optical pickup and the track of the optical disc in the radial direction, from the output of the optical pickup unit, a signal correction unit for correcting the tracking error signal, and an optical pickup drive unit for moving the optical pickup unit in the radial direction of the optical disc, wherein the signal correction unit corrects the tracking error signal when the laser beam is irradiated to the address information recording portion indicating an address of the optical disc, and the optical pickup drive unit moves the optical pickup unit in the radial direction of the optical disc by using the corrected tracking error signal.

Other objects, features, advantages of the present invention will be made clear from the description of the embodiment of the present invention with reference to the attached drawings.

### BRIEF DESCRIPTION OF THE DRAWINGS

FIG. 1 is a diagram for explaining a tracking jump operation of an optical disc.

FIG. 2 is a diagram for explaining a tracking jump operation in a DVD-RAM disc.

FIG. 3 is a block diagram showing configuration of an information recording/reproducing apparatus according to an embodiment of the present invention.

FIG. 4A and FIG. 4B are diagrams for explaining the structure of the DVD-RAM disc.

FIG. 5 is a table for storing the timing of the tracking jump.

FIG. 6 is an operation flowchart of the tracking jump.

FIG. 7A, FIG. 7B and FIG. 7C are diagrams for explaining the operation of a tracking jump start timing detection unit.

FIG. 8A to FIG. 8D are diagrams each for indicating the relationship between the tracking error signal and the physical identifier.

FIG. 9 is a diagram for explaining the operation of a tracking error signal correction unit.

FIG. 10 is a diagram for showing the waveform of FIG. 9 with the time axis expanded.

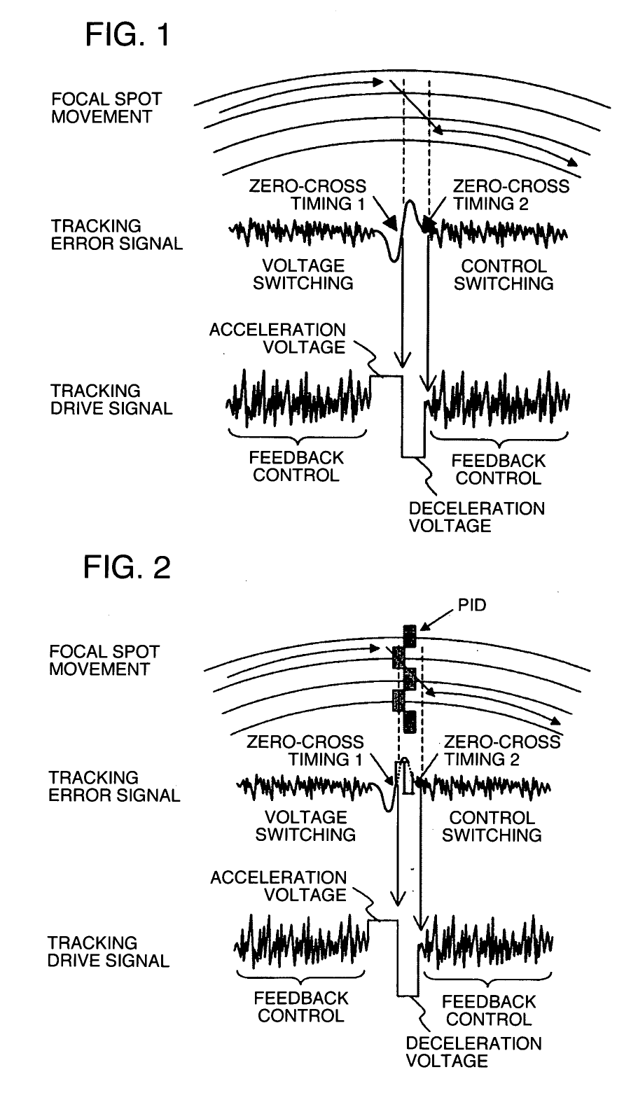

### DESCRIPTION OF THE EMBODIMENTS

Description will now be directed to an embodiment of the present invention with reference to the drawings. Like members are denoted by like reference symbols.

1. Outline of the Embodiment

Firstly, explanation will be given on the outline of the embodiment. As has been described above, when the recording speed or the reproduction speed of the DVD-RAM is increased, it becomes impossible to avoid crossing of a physical identifier (PID) during a tracking jump and the tracking jump may fail and the reproduction operation or the recording operation may fail. In this embodiment, this problem is solved by the following techniques.

(1) The timing of the tracking jump is controlled so that the timing of crossing of the physical identifier is not overlapped with the zero-cross timing of the tracking error signal.

(2) The tracking error signal at the timing of crossing the physical identifier is corrected.

2. Configuration of the Optical Disc Drive

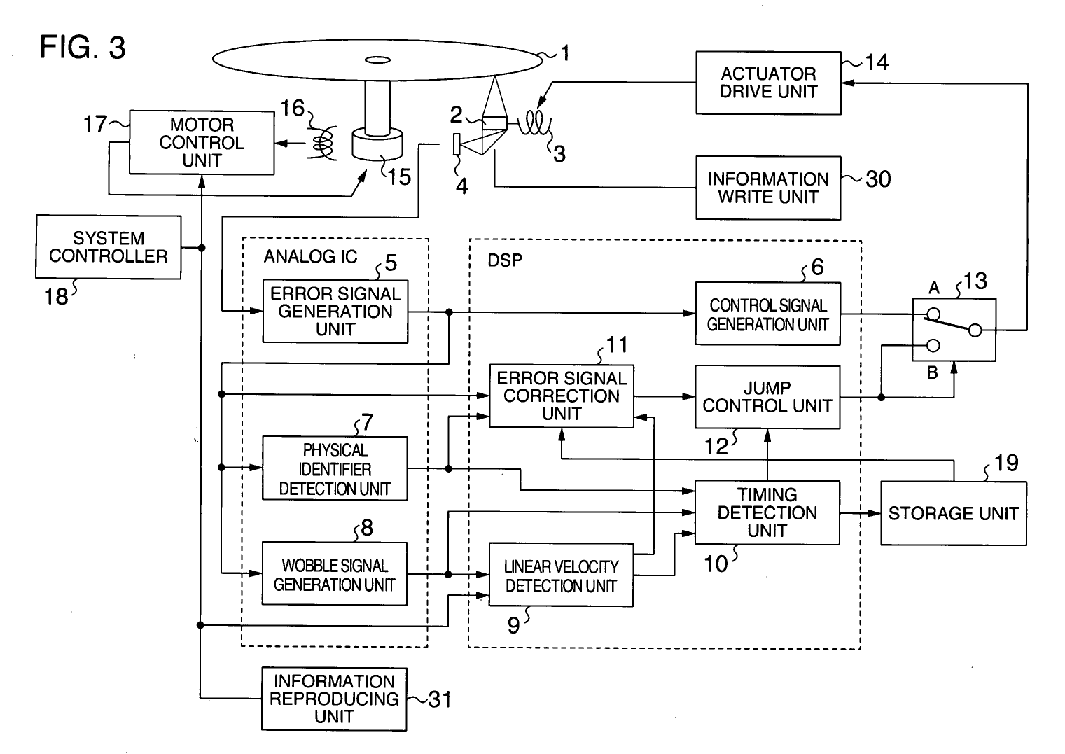

Next, explanation will be given on configuration of the optical disc drive according to the present embodiment with reference to FIG. 3. In FIG. 3, the optical disc drive includes a disc 1, an optical pickup 2 including an objective lens, a tracking actuator 3 for moving the objective lens in the disc radial direction, a detector 4, a tracking error signal generation unit (signal generation unit) 5 for generating an error signal in the tracking direction of the disc track and the objective lens, a tracking control signal generation unit 6 for controlling the tracking actuator so that focal spot is positioned at the disc track, a physical identifier detection unit 7, a wobble signal generation unit 8 for generating a track wobble signal, a linear velocity detection unit 9 for detecting the linear velocity of the focal spot moving along the track, a tracking jump start timing detection unit 10 for detecting the start timing of the tracking jump, a tracking error signal correction unit (signal correction unit) 11 for correcting the tracking error signal during a crossing of the physical identifier, a tracking jump control unit 12, a switching unit 13, a tracking actuator drive unit 14 for driving the tracking actuator, a spindle motor 15 for rotating the disc, a frequency generation unit 16 for generating a signal in accordance with the rotation speed of the motor, a motor control unit 17 for controlling the spindle motor to rotate at a predetermined angular velocity, and a system controller 18. A storage unit 19 stores a tracking jump timing (for example, the number of wobbles from the physical identifier, N5, N8, N12, N16, . . . ) in accordance with the disc linear velocity (for example, 5×-speed, 8×-speed, 12×-speed, 16×-speed, . . . ) as a table.

The optical disc drive further has an information write unit 30 and an information reproducing unit 31, which are similar to those used in general information recording and reproducing apparatuses and no explanation thereof will be necessary for those ordinary skilled in the art.

The tracking error signal generation unit 5, the physical identifier detection unit 7, and the wobble signal generation unit 8 are arranged in an analog IC. Moreover, the tracking control signal generation unit 6, the linear velocity detection unit 9, the tracking jump start timing detection unit 10, the tracking error signal correction unit 11, and the tracking jump control unit 12 are arranged in a digital signal processing unit (DSP) and these may be hardware or software.

Next, explanation will be given on the outline of the operation of each block and the relationship between the blocks.

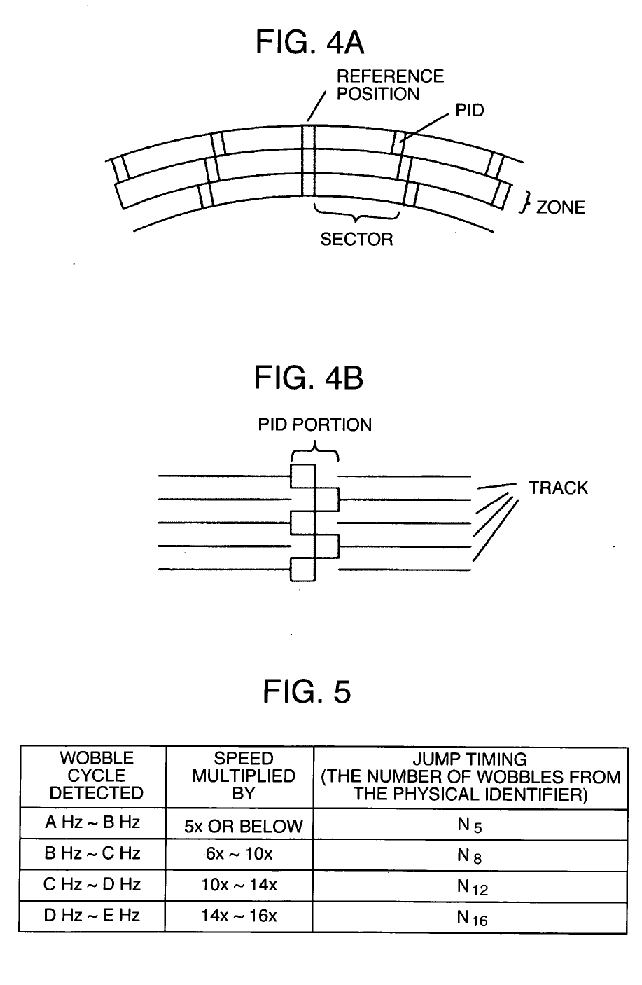

The disc 1 is a DVD-RAM disc. The optical disc drive can perform reproduction and recording from/to the disc 1. FIG. 4 shows configuration of the DVD-RAM disc. As shown in FIG. 4A, the DVD-RAM disc has zones arranged in the disc radial direction. Moreover, each zone has sectors in the disc circumferential direction. Each sector has a physical identifier (PID) indicating address information. As shown in FIG. 4B, the physical identifier portion is arranged alternately at the boundary of the tracks.

The optical pickup 2 includes an objective lens. In reproduction, the optical pickup 2 irradiates a laser beam for reading data from the disc 1. In recording, the optical pickup 2 irradiates a laser beam for writing data onto the disc 1. The optical pickup 2 and the detector 4 constitute an information read unit for reading information recorded on the optical disc as an information recording medium.

The tracking actuator 3 moves the objective lens of the optical pickup 2 in the disc radial direction. The detector 4 converts the reflected light of the laser beam from the disc 1 into an electric signal and sends the converted signal to the tracking error signal generation unit 5. The tracking error signal generation unit 5 generates a tracking error signal from the received signal and sends the generated tracking error signal to the tracking control signal generation unit 6, the physical identifier detection unit 7, the wobble signal generation unit 8, and the tracking error signal correction unit 11. The tracking control signal generation unit 6 generates a tracking control signal based on the received signal and sends the generated tracking control signal to the switching unit 13.

Based on the received signal, the physical identifier detection unit 7 detects a physical identifier (PID) on the track and sends a PID signal indicating that physical identifier is being crossed to the tracking jump start timing detection unit 10 and the tracking error signal correction unit 11.

The wobble signal generation unit 8 generates a wobble signal based on the received signal and sends the generated signal to the linear velocity detection unit 9 and the tracking jump start timing detection unit 10. The system controller 18 sends the disc rotation instruction information and the address information to the linear velocity detection unit 9, and the disc rotation instruction information to the motor control unit 17. Here, the disc rotation instruction information is information instructing the rotation speed of the spindle motor 15 and the address information is information relating to the address indicating a position on the disc.

The linear velocity detection unit 9 detects a wobble cycle from the received signal, converts the detected wobble cycle into linear velocity information, and sends the generated linear velocity information to the tracking jump start timing detection unit 10. When the wobble cannot be detected correctly, a rough linear velocity is calculated from the information received from the system controller 18 and the calculated linear velocity information is sent to the tracking jump start timing detection unit 10. Moreover, it is also possible to detect the linear velocity by directly detecting the rotation speed of the spindle motor 15. Furthermore, it is also possible to detect the linear velocity by measuring a period between a crossing of a physical identifier and a crossing of the next physical identifier. By using these techniques, the linear velocity can be calculated even when the wobble cannot be detected correctly. When the last-mentioned technique is employed, the tracking jump operation time becomes longer by one sector but, as the tracking jump control performance, an equivalent effect can be obtained. It should be noted that detection of the linear velocity is performed because when the angular velocity is used, the reproduction speed or the recording speed is changed by the disc radial position and it is necessary to accurately detect a speed according to the recording position or the reproduction position.

The tracking jump start timing detection unit 10 calculates a tracking jump start timing as a wobble count value from the signal received from the physical identifier detection unit 7, the signal received from the wobble signal generation unit 8, and information received from the linear velocity detection unit 9 and sends the calculated tracking jump start signal to the tracking jump control unit 12. When the wobble cannot be detected correctly, the tracking jump start timing is calculated as a time elapse after the physical identifier is crossed, from the signal received from the physical identifier 7 and the information received from the linear velocity detection unit 9. The calculated tracking jump start signal is sent to the tracking jump control unit 12. Detection of the tracking jump start timing will be detailed later.

The tracking error signal correction unit 11 corrects a tracking error signal in a physical identifier period from the signal received from the tracking error signal generation unit 5 and the signal received from the physical identifier detection unit 7 and sends the corrected tracking error correction signal to the tracking jump control unit 12. Correction of the tracking error signal will be detailed later.

The tracking jump control unit 12 outputs a tracking jump drive signal from the signal received from the tracking jump start timing detection unit 10 and the signal received from the tracking error signal correction unit 11 and simultaneously with this, sends a tracking jump start and end signal to the switching unit 13.

Based on the output of the tracking jump control unit 12, the switching unit 13 sends the output of the tracking control signal generation unit 6 or the output of the tracking jump control unit 12 to the tracking actuator drive unit 14. When performing a normal reproduction operation or recording operation, the switch is set to side A and a signal is output to control the tracking actuator so that the focal spot is positioned on the disc track. Moreover, when performing a tracking jump operation, the switch is set to side B and a signal is output to control the track actuator so that a tracking jump is performed at a predetermined timing.

The tracking actuator drive unit 14 drives the tracking actuator 3 based on the signal received from the switching unit 13. The tracking actuator 3 and the tracking actuator drive unit 14 constitute an information read drive unit. The spindle motor 15 drives the disc 1 and rotates the disc at a predetermined rotation speed according to the signal from the motor control unit 17. The frequency generation unit 16 detects rotation information on the spindle motor 15 and sends the detected information to the motor control unit 17. The motor control unit 17 controls the spindle motor 15 so that the disc 1 is rotated at a predetermined rotation speed.

The storage unit 19 stores a jump timing corresponding to the rotation speed. More specifically, as shown in FIG. 5, the detected wobble cycle, rotation speed, and jump timing are stored in a table. For example, when the detected wobble cycle is AHz to BHz, the rotation speed is 5×-speed or below and the appropriate jump timing in this case is the timing of the N5-th wobble from the physical identifier.

Thus, the storage unit 19 stores the jump timing in accordance with the rotation speed so as to perform such a setting that the zero-cross timing 1 for switching the acceleration voltage to the deceleration voltage applied to the actuator 3 and the zero-cross timing 2 for switching from the deceleration voltage application to the normal feedback control are not overlapped with the physical identifier period. That is, the tracking jump timing is controlled in accordance with the rotation speed so that the timing of crossing of the physical identifier is not overlapped with the zero-cross point, thereby preventing failure of the tracking jump.

3. Detection of the Tracking Jump Start Timing

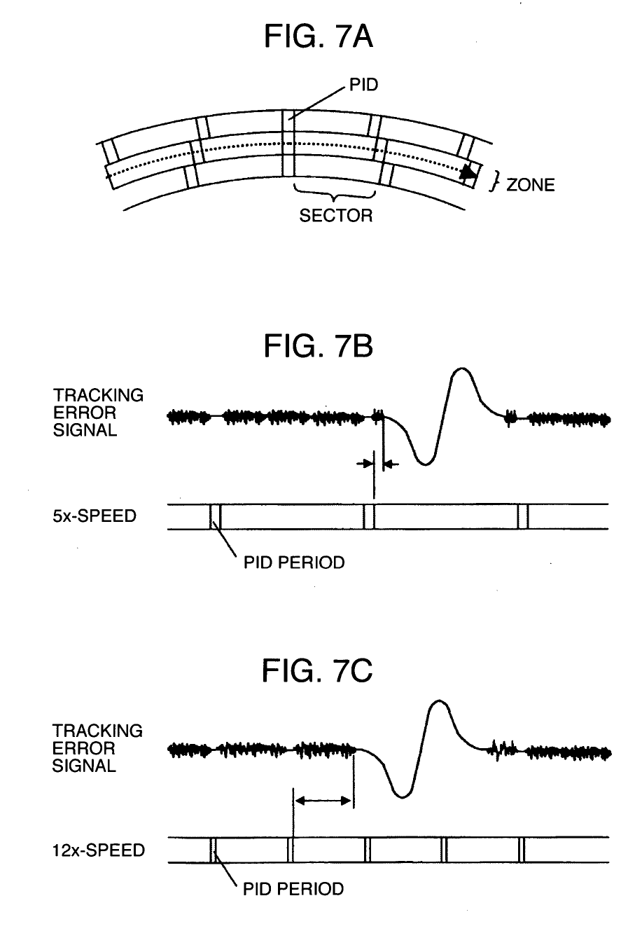

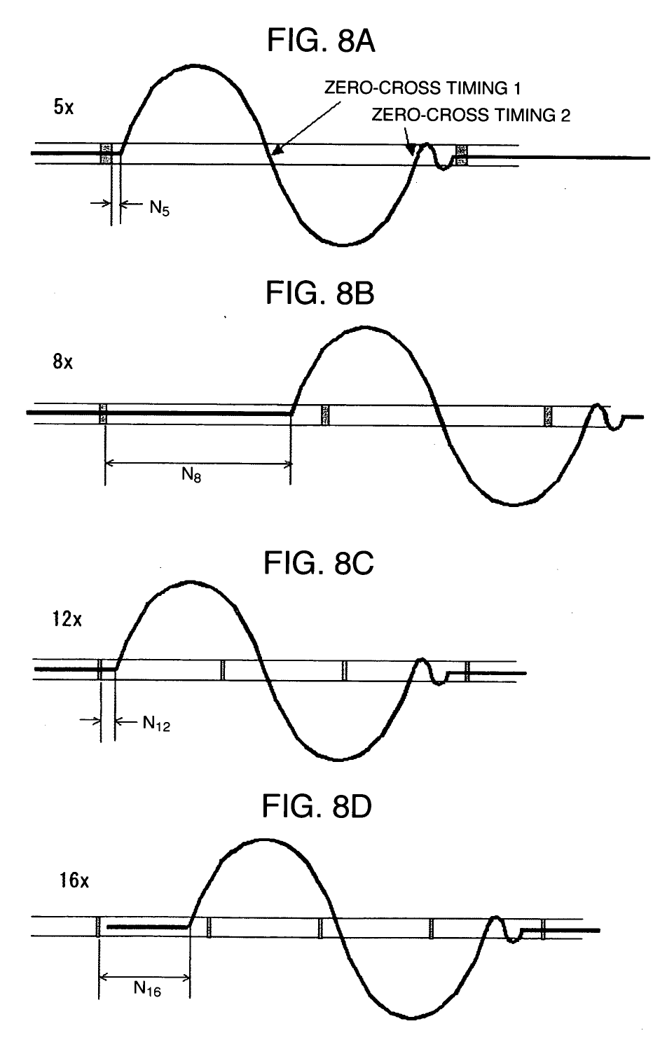

Next, detailed explanation will be given on the operation of the tracking jump start timing detection unit 10 with reference to FIGS. 7A to 7C and FIGS. 8A to 8D,

FIG. 7A shows the structure of the DVD-RAM disc, FIG. 7B shows the relationship between the tracking error signal having the linear velocity of 5×-speed and the physical identifier, and FIG. 7C shows the relationship between the tracking error signal having the linear velocity of 12×-speed and the physical identifier.

As shown in FIG. 7B, when the linear velocity is 5×-speed or below, the tracking jump is started immediately after crossing the physical identifier and the tracking jump can be completed before reaching the next physical identifier. However, as shown in FIG. 7C, when the linear velocity exceeds the 5×-speed (such as 12×-speed), the track jump cannot be completed before reaching the next physical identifier and the next physical identifier is crossed. In such a case, control should be made that the zero-cross timing is not overlapped with the physical identifier crossing timing.

FIG. 8A to FIG. 8D show the relationship of the tracking error signal and the physical identifier when the linear velocity is 5×-speed, 8×-speed, 12×-speed, and 16×-speed, respectively. The N5, N8, N12, and N16 are the jump timing (the number of wobbles from the physical identifier) in accordance with the respective linear velocity stored in the table of FIG. 5. That is, after the tracking jump start timing detection unit 10 receives the physical identifier detection signal from the physical identifier detection unit 7, it performs counting of wobbles by the signal from the wobble generation unit 8, detection of linear velocity by the signal from the linear velocity detection unit 9, reading of the jumping timing in accordance with the linear velocity from the storage unit 19, thereby deciding the optimal tracking jump start timing.

Firstly, explanation will be given on the case of FIG. 8A. The linear velocity is 5×-speed. If the track jump is started immediately after crossing a physical identifier, the tracking jump can be completed before reaching the next physical identifier. Accordingly, the track jump is started at the jump timing immediately after crossing a physical identifier. That is, in this case, the number of wobbles N5 from the physical identifier is preferably 0, 1, or 2.

Next, explanation will be given on the case of FIG. 8B. The linear velocity is 8×-speed. Even if the track jump is started immediately after crossing a physical identifier, the tracking jump cannot be completed before crossing the next physical identifier because the linear velocity is high. Accordingly, the track jump is not started immediately after crossing a physical identifier. Instead, the tracking jump is started when the number of wobbles from the physical identifier is N8. When the tracking jump is started at this timing, the zero-cross timing 1 for switching the acceleration voltage to the deceleration voltage and the zero-cross timing 2 for terminating the deceleration voltage and setting the normal feedback control are not overlapped with the physical identifier crossing timing, thereby preventing the failure of the tracking jump. That is, as shown in FIG. 8B, zero-cross is not performed eve if the tracking error signal is changed into a false signal and it is possible to prevent erroneous detection of the timing.

In the cases of FIG. 8C and FIG. 8D, like the case of FIG. 8B, the tracking jump is performed at the jump timing (the number of wobbles from the physical identifier is N12, N16) when the zero-cross timing 1 and the zero-cross timing 2 are not overlapped with the physical identifier crossing timing.

Thus, by controlling the tracking jump start timing, it becomes possible to prevent erroneous detection of the timing even if the tracking error signal is changed into a false signal and prevent failure of the tracking jump.

It should be noted that here, as information on the timing of the tracking jump, the number of wobbles is given but the information is not to be limited to this. It is possible to use position information or time information. For example, the timing of the tracking jump can be detected by counting the wobbles but when wobbles cannot be detected, the time after crossing a physical identifier can be used for management. In this case, in the table of FIG. 5, the time after crossing the physical identifier is stored instead of the number of wobbles after crossing the physical identifier. Thus, even when the wobbles cannot be detected appropriately, it is possible to accurately perform a tracking jump.

Here, explanation has been given on a case that the table of the storage unit 19 stores appropriate jumping timing for each of the four ranges of the linear velocity: a range of 5×-speed or below, a range not less than 6×-speed and less than 10×-speed, a stage not smaller than 10×-speed and smaller than 14×-speed, and a range not less than 14×-speed and not greater than 16×-speed. However, the storage unit 19 may store appropriate jump timing for each of the speeds such as the speed not greater than 5×-speed, 6×-speed, 7×-speed, . . . , 15×-speed, 16×-speed. This enables more accurate tracking jump.

Moreover, explanation has been given on a case that the table stores the jump timing for the linear velocity up to 16×-speed. However, the table may also store the jump timing for the linear velocity higher than this such as 18×-speed, 20×-speed, 24×-speed. This enables recording/reproduction of a higher speed.

4. Correction of Tracking Error Signal

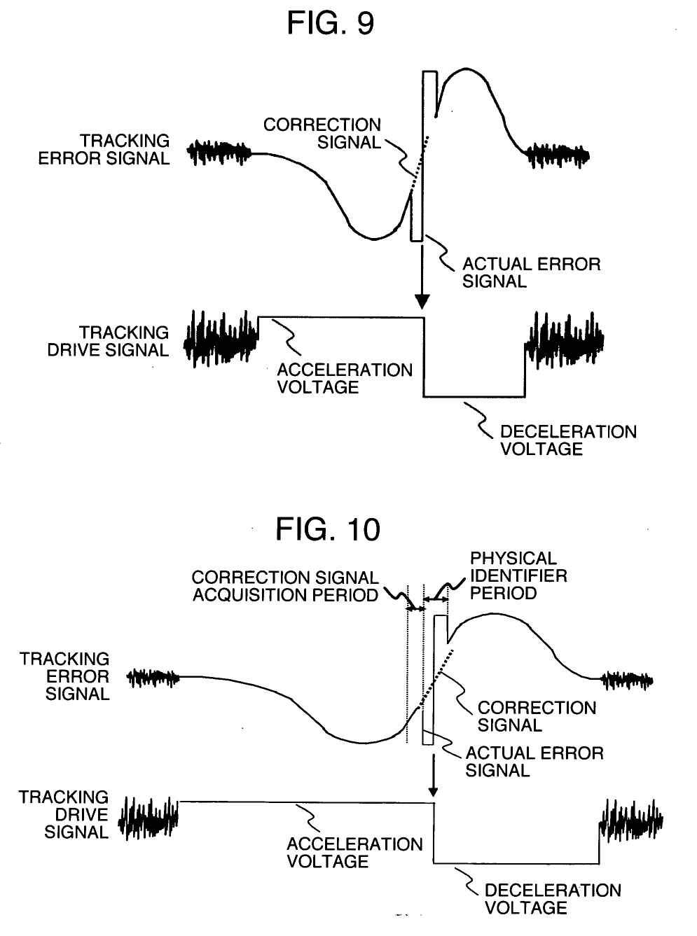

Next, explanation will be given on the detailed operation of the tracking error signal correction unit 11 with reference to FIG. 9.

FIG. 9 shows a tracking error signal and a tracking drive signal when the focal spot crosses the physical identifier portion during a tracking jump.

As shown by a solid line, the tracking error signal crossing a physical identifier is changed into a false signal and cannot indicate the actual positional relationship between the focal spot and the track. Accordingly, there is a danger of making an error in determining the zero-cross timing 2 for switching the acceleration voltage to reduction voltage and the zero-cross timing 2 for terminating the reduction voltage application and setting the normal feedback control.

To cope with this, the tracking error signal correction unit 11 detects and stores the inclination of the tracking error signal during a predetermined period after crossing the physical identifier portion shown in the figure and before crossing the next physical identifier portion. During the physical identifier period, a correction signal of the tracking error signal is generated as shown by the dotted line from the detected inclination. This will be further detailed with reference to FIG. 10.

FIG. 10 is an enlarged view of the waveform in FIG. 9 enlarged in the time axis for explaining acquisition of an interpolation signal and correction of a tracking error signal. Firstly, inclination of the tracking signal immediately before crossing the physical identifier is acquired and an interpolation signal indicated by the broken line is generated by utilizing the acquired inclination. A correction signal is generated by interpolating the tracking signal during the actual physical identifier period by the interpolation signal. The acquisition period of the correction signal is preferably immediately before crossing of the physical identifier.

More specifically, the tracking error signal correction unit 11 calculates the crossing time of the next physical identifier according to the linear velocity information received from the linear velocity detection unit 9, calculates inclination of the tracking error signal before a predetermined time of the calculated time, generates a correction signal by using the inclination, and detects the zero-cross timing by using the correction signal until the crossing of the physical identifier is completed. The correction signal temporarily generates a pseudo-tracking error signal, thereby realizing an accurate tracking jump even if the zero-cross timing is overlapped with the timing of crossing of the physical identifier.

It should be noted that when two or more physical identifiers are crossed during a tracking jump, the time required for crossing the physical identifiers is calculated and the correction signal is generated. The number of physical identifiers to be crossed is stored in advance for each linear velocity in the table of FIG. 5 and the physical identifier crossing time is calculated for each of the physical identifiers.

Thus, by correcting the tracking error signal, it is possible to realize a stable tracking jump without performing the aforementioned tracking jump timing control. Furthermore, even when the aforementioned tracking jump timing control is performed, the tracking jump timing may be shifted by the disc eccentricity, distortion, deformation, or irregularities of the actuator sensitivity. In such a case, by using the present technique, it is possible to perform an accurate tracking jump and realize a further stable tracking jump.

It should be noted that a correct correction signal cannot be generated in the vicinity of the inflection point of the tracking error signal but in this case, the physical identifier is crossed in the vicinity of the inflection point and actually no problem is caused. When the tracking error signal crosses the physical identifier at the timing in the vicinity of the reference voltage, i.e., at the zero-cross timing, since the difference between the correction signal and the position of the actual focal spot is reduced, it is possible to minimize the delay of switching between the acceleration and reduction voltage and the delay of the jump control completion.

5. Flowchart of Tracking Jump

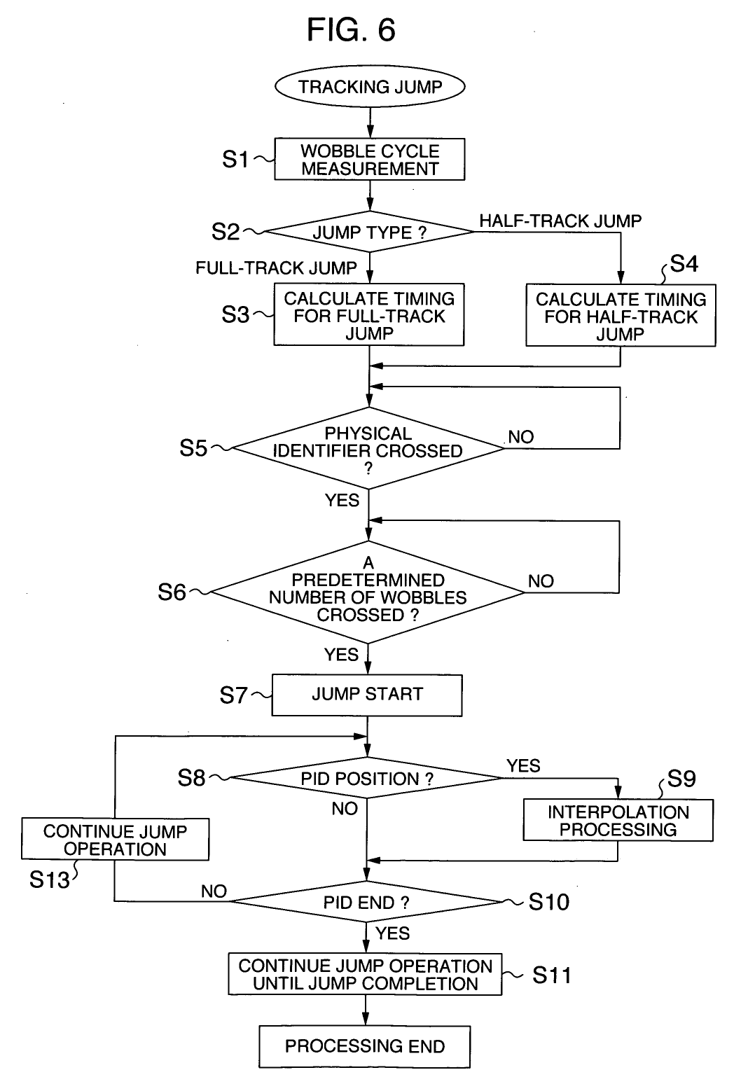

Next, explanation will be given on the flow of the tracking jump operation according to the present embodiment with reference to FIG. 6. It should be noted that the flow of FIG. 6 assumes that a laser beam from the optical pickup 2 is applied onto the rotating optical disc 1 and based on the tracking error signal generated from the reflected light from the optical disc, the information track on the optical disc is scanned by the laser beam (focal spot). The operation flow of FIG. 6 can be applied to the information recording and reproduction.

(1) When a tracking jump command is issued, firstly, the linear velocity of the optical disc 1 is detected (S1). Detection of the linear velocity is performed by the linear velocity detection unit 9 which detects a wobble cycle from the signal received from the wobble generation unit 8 and converts the wobble cycle into linear velocity information.

(2) Based on the tracking jump command issued, the tracking jump is classified as a half-track jump or a full-track jump (S2). The half-track jump is a tracking jump from a disc land to the adjacent groove while the full-track jump is a tracking jump from a disc land via the adjacent groove further to the adjacent land. Either of them is included as one form of the tracking jump. Two types of track jump are classified because the half-track jump crosses the track once while the full-track jump crosses the track twice. Accordingly, the tracking error signal has a different waveform and control of the tracking jump is also different.

(3) The timings of the full-track jump and the half-track jump are calculated (S3, S4). The timing of the tracking jump is calculated by referencing the table in FIG. 5 stored in the storage unit 19 and reading out the number of wobbles appropriate to the disc linear velocity. The storage unit 19 stores a table for the full-track jump and a table for the half-track jump and it is possible to calculate the timing of the tracking jump appropriate for each of them. For example, in the case of the full-track jump, the tracking jump period is long and the timing to evade crossing the physical identifier is limited while in the case of the half-track jump, the tracking jump period is short and the timing has a greater degree of freedom. Consequently, in the case of the half-track jump, the tracking jump can be performed at a greater number of timings.

(4) It is detected whether a physical identifier is crossed (S5). Crossing of a physical identifier is detected by a physical identifier detection unit 7. When no physical identifier is detected (NO in S5), wait mode is set in, i.e., no tracking jump is performed until a physical identifier is detected. When a physical identifier is detected (YES in S5), counting of the number of wobbles after crossing the physical identifier is started and control is passed to step S6.

(5) It is judged whether a predetermined number of wobbles, i.e., the calculated predetermined number of wobbles have been passed (S6). When the number of wobbles passed is less than the predetermined number (NO in S6), a wait state continues until the number of wobbles reaches the predetermined value. When the number of wobbles has reached the predetermined number (YES in S6), control is passed to S7.

(6) The tracking actuator is accelerated and the tracking jump is started (S7). More specifically, after feedback control of the tracking control system is turned off, a predetermined acceleration voltage is applied to the tracking actuator 3 and the objective lens of the optical pickup 2 is accelerated in the direction of the adjacent track.

(7) After the tracking jump is started, it is checked whether the focal spot has reached the position of the next physical identifier (S8). This is because even when the tracking jump is started at the timing when the zero-cross timing and the physical identifier portion crossing are not overlapped, the timing may still be shifted and irregularities of the tracking jump time may still be caused and hence it is preferable to correct the tracking error signal when crossing the physical identifier. Judgment whether the physical identifier portion position has been reached is made as follows. The time between the time of crossing the previous physical identifier and the time of crossing the next physical identifier is calculated from the detected linear velocity and it is checked whether the time has elapsed from the previous physical identifier portion as a reference. After the tracking jump is started, the number of wobbles cannot be counted and it is appropriate to calculate the time to make judgment.

When it is decided that the focal spot has reached the position of the next physical identifier portion (YES in S8), control is passed to S9, where the tracking error signal is corrected. On the other hand, when it is decided that the focal spot has not reached the position of the next physical identifier portion (NO in S8), control is passed to S10.

(8) It is judged whether the focal spot has crossed the physical identifier portion (S10). If the focal spot has not yet crossed the physical identifier portion (NO in S10), the jumping operation is continued (S13). When the focal spot has crossed the physical identifier portion, the operation is continued until the tracking jump is completed (S11).

It should be noted that the tracking jump operation is mainly control operation of the tracking actuator 3. When it is detected that the tracking error signal has returned to the reference value (zero-cross timing 1), the acceleration voltage applied to the tracking actuator 3 is switched to the deceleration voltage. When it is detected that the tracking error signal has returned again to the reference value (zero-cross timing 2), feedback control of the tracking control system is turned on.

It should be noted that (1) the method for controlling the tracking jump timing so that the timing of crossing of the physical identifier portion is not overlapped by the zero-cross point of the tracking error signal and (2) the method for correcting the error signal generated when crossing the physical identifier portion have been explained in one flowchart. However, each of the methods may be performed independently from each other. That is, tracking jump may be performed by using only the method of (1) and tracking jump may be performed by using only the method of (2). When executing the method of (1) or (23) independently, the tracking jump can be performed by a simplified process. When employing the both methods simultaneously, it is possible to realize a more stable tracking jump.

As has been described above, by optimizing the tracking jump start timing according to the linear velocity of the focal spot, it is possible to avoid coincidence of the zero-cross timing of the tracking error signal and the physical identifier crossing period. Moreover, by correcting the tracking error signal, it is possible to prevent erroneous detection of the timing. Thus, it is possible to obtain accurate switching timing between acceleration and reduction of the optical pickup and accurate start timing of the feedback control, which in turn realizes the stable tracking jump operation and improves the reliability of the device.

It should be noted that explanation has been given on the example of the DVD-RAM disc in this embodiment but the present embodiment is not to be limited to this. For example, the present embodiment may be applied to other types of optical disc (CD-R/RW, DVD-R/RW, BD, etc.), a magneto-optical disc (MO, etc.) and a magnetic disc (HD, etc.). The present embodiment can be applied to a recording medium in which a tracking error signal is changed into a false signal by some reason or other when the tracking jump is performed and it becomes impossible to grasp an accurate positional relationship between the focal spot and the track.

Moreover, the embodiment has been explained mainly on the example of full-track jump. However, the same effect can also be obtained by the same method in the case of half-track jump.

Moreover, in this embodiment, explanation has been given on the case of the tracking jump to the adjacent track. However, the method of the present embodiment can also be applied to track movement beyond several tracks (2, 3 tracks). In this case, three or more zero-crosses are generated. This case can be realized by storing a table such that the zero-crossings which determine the timing for switching between acceleration and deceleration and the feedback switching timing are not overlapped by the physical identifier.

According to the aforementioned embodiments, it is possible to provide an information recording device, an information reproduction device, an information recording method, and information reproduction method having a high reliability.

The present invention has been explained through the embodiment but the present invention may be modified and changed within the spirit of the invention and in the scope of the attached claims.

1. An optical disc reproducing apparatus for reproducing information from an optical disc, the apparatus comprising:
an optical pickup unit for irradiating a laser beam onto the optical disc,
an optical pickup drive unit for moving the optical pickup unit in the radial direction of the optical disc, and
a motor unit for rotating the optical disc,
wherein after the laser beam irradiated to the optical disc crosses the address information recording portion indicating an address of the optical disc, the optical pickup drive unit moves the optical pickup unit in the radial direction of the optical disc at the timing corresponding to the rotation speed of the optical disc.

2. An optical disc reproducing apparatus as claimed in claim 1, the apparatus further comprising a storage unit for storing timing information concerning the timing in accordance with the rotation speed of the optical disc,
wherein the optical pickup unit moves the optical pickup in the radial direction of the optical disc at the timing stored in the storage unit.

3. An optical disc reproducing apparatus as claimed in claim 1, the apparatus further comprising:
an address information recording portion detection unit for detecting the address information recording portion of the optical disc,
a rotation speed detection unit for detecting the rotation speed of the optical disc,
wherein after the address information recording portion is detected by the address information recording portion detection unit, the optical pickup drive unit moves the optical pickup unit in the radial direction of the optical disc at the timing corresponding to the rotation speed detected by the rotation speed detection unit.

4. An optical disc reproducing apparatus as claimed in claim 1, wherein the timing is a timing where the timing when the tracking error signal indicating a relative position in the radial direction with the track of the optical disc is not overlapped with the timing when the laser beam crosses the address information recording portion of the optical disc.

5. An optical disc reproducing apparatus as claimed in claim 4, wherein the timing when the tracking error signal becomes a predetermined reference value is a zero-cross timing.

6. An optical disc reproducing timing as claimed in claim 1, wherein the optical disc is a DVD-RAM disc and the address information recording portion includes a physical identifier.

7. An optical disc reproducing apparatus as claimed in claim 1, wherein the movement in the radial direction of the optical disc is a tracking jump as movement to an adjacent track of the optical disc.

8. An optical disc reproducing apparatus as claimed in claim 7, wherein the tracking jump includes a half-track jump which is a movement from a groove to an adjacent land or from a land to a groove of the optical disc and a full-track jump which is a movement from a groove to the nearest groove or from a land to the nearest land of the optical disc.

9. An optical disc reproducing apparatus for reproducing information from an optical disc, the apparatus comprising:
an optical pickup unit for irradiating a laser beam to the optical disc,
a signal generation unit for generating a tracking error signal indicating the relative position between the optical pickup and the track of the optical disc in the radial direction, from the output of the optical pickup unit,
a signal correction unit for correcting the tracking error signal, and
an optical pickup drive unit for moving the optical pickup unit in the radial direction of the optical disc,
wherein the signal correction unit corrects the tracking error signal when the laser beam is irradiated to the address information recording portion indicating the address of the optical disc, and
the optical pickup drive unit moves the optical pickup unit in the radial direction of the optical disc by using the corrected tracking error signal.

10. An optical disc reproducing apparatus as claimed in claim 9, wherein the optical disc is a DVD-RAM disc and the address information recording portion includes a physical identifier.

11. An optical disc reproducing device as claimed in claim 9, wherein the movement in the radial direction of the optical disc is a tracking jump which is a movement to an adjacent track of the optical disc.

12. An optical disc reproducing apparatus as claimed in claim 11, wherein the tracking jump includes a half-track jump which is a movement from a groove to an adjacent land or from a land to a groove of the optical disc and a full-track jump which is a movement from a groove to the nearest groove or from a land to the nearest land of the optical disc.

13. An optical disc reproducing apparatus for reproducing information from an optical disc, the apparatus comprising:
an optical pickup unit for irradiating a laser beam to the optical disc,
a signal generation unit for generating a tracking error signal indicating a relative position between the optical pickup unit and the track of the optical disc in the radial direction, from the output of the optical pickup unit,
a signal correction unit for correcting the tracking error signal,
an optical-pickup drive unit for moving the optical pickup in the radial direction of the optical disc, and
a motor unit for rotating the optical disc,
wherein after the laser beam irradiated to the optical disc crosses the address information recording portion indicating the address of the optical disc, the optical pickup drive unit moves the optical pickup unit in the radial direction of the optical disc at the timing corresponding to the rotation speed of the optical disc,
the signal correction unit corrects the tracking error signal while the laser beam is irradiated to the address information recording portion indicating the address of the optical disc when the optical pickup unit is moved in the radial direction of the optical disc, and
the optical pickup drive unit continues movement of the optical pickup unit in the radial direction of the optical disc by using the corrected tracking error signal.

14. An optical disc reproducing apparatus as claimed in claim 13, wherein the optical disc is a DVD-RAM disc and the address information recording portion includes a physical identifier.

15. An optical disc reproducing apparatus as claimed in claim 13, wherein the movement in the radial direction of the optical disc is a tracking jump for a movement to an adjacent track of the optical disc.

16. An optical disc reproducing apparatus as claimed in claim 15, wherein the tracking jump includes a half-track jump which is a movement from a groove to an adjacent land or from a land to a groove of the optical disc and a full-track jump which is a movement from a groove to the nearest groove or from a land to the nearest land of the optical disc.

17. An optical disc recording apparatus for recording information onto an optical disc, the apparatus comprising:
an optical pickup for irradiating a laser beam to the optical disc,
an optical pickup drive unit for moving the optical pickup unit in the radial direction of the optical disc, and
a motor unit for rotating the optical disc,
wherein after the laser beam irradiated to the optical disc crosses the address information recording portion indicating an address of the optical disc, the optical pickup drive unit moves the optical pickup unit in the radial direction of the optical disc at the timing in accordance with the rotation speed of the optical disc.

18. An optical disc recording apparatus for recording information onto an optical disc, the apparatus comprising:
an optical pickup unit for irradiating a laser beam onto the optical disc,
a signal generation unit for generating a tracking error signal indicating the relative position between the optical pickup unit and the optical disc track in the radial direction, from the output of the optical pickup unit,
a signal correction unit for correcting the tracking error signal, and
an optical pickup drive unit for moving the optical pickup unit in the radial direction of the optical disc,
wherein the signal correction unit corrects the tracking error signal when the laser beam is irradiated to the address information recording portion indicating an address of the optical disc, and
the optical pickup drive unit moves the optical pickup unit in the radial direction of the optical disc by using the corrected tracking error signal.

19. An optical disc reproducing apparatus for reproducing information from an optical disc, the apparatus comprising:
a tracking actuator for driving an objective lens of an optical pickup,
tracking error signal generation unit for generating a tracking error signal indicating the relative position between the objective lens and the optical disc track in the radial direction,
a physical identifier detection unit for detecting a physical identifier including physical address information on the optical disc,
a linear velocity detection unit for detecting the velocity of the laser beam moving along the track of the optical disc,
a tracking jump control unit for controlling the tracking actuator so that the laser beam irradiated from the optical pickup moves to the adjacent track, and
a tracking jump start timing detection unit for calculating the timing for starting movement to the adjacent track according to the output from the linear velocity detection unit and the output from the physical identifier detection unit,
wherein the tracking jump control unit controls the tracking actuator by the signal from the tracking jump start timing detection unit.

20. An optical disc reproducing apparatus as claimed in claim 19, the apparatus further comprising:
a wobble signal generation unit for generating a wobble of the track of the optical disc,
wherein the tracking jump start timing detection unit calculates the timing to start the tracking jump according to the outputs from the linear velocity detection unit, the physical identifier detection unit, and the wobble signal generation unit.

21. An optical disc reproducing apparatus as claimed in claim 19, where the tracking jump start timing detection unit calculates the timing to start a tracking jump according to the output from the linear velocity detection unit and the physical identifier detection unit.

22. An optical disc reproducing apparatus as claimed in claim 19, the apparatus further comprising a tracking error signal correction unit for correcting the tracking error signal while the laser beam is crossing the physical identifier portion by using the tracking error signal before crossing the physical identifier portion based on the output from the tracking error signal generation unit and the physical identifier detection unit.

23. An information reproducing apparatus for reproducing information from a disc-shaped recording medium, the apparatus comprising:
an information read unit for reading information recorded in the recording medium,
an information read drive unit for moving the information read unit in the radial direction of the recording medium, and
a recording medium rotation unit for rotating the recording medium,
wherein after the read position of the information read unit with respect to the recording medium has passed the address information recording portion indicating the address of the recording medium, the information read unit moves the information read unit in the radial direction of the recording medium at the timing in accordance with the rotation speed of the recording medium.

24. An information reproducing apparatus for reproducing information from a disc-shaped recording medium, the apparatus comprising:
an information read unit for reading information recorded on the recording medium,
a signal generation unit for generating a signal indicating the relative position between the information read unit and the recording medium track in the radial direction, from the output from the information read unit,
a signal correction unit for correcting the generated signal, and
an information read drive unit for moving the information read unit in the radial direction of the recording medium,
wherein the signal correction unit corrects the generated signal while the information read unit is reading the address information recording unit indicating the address of the recording medium, and
the information read drive unit moves the information read unit in the radial direction of the recording medium by using the corrected signal.

25. An information reproducing method used in an optical disc recording/reproducing apparatus for reproducing information from an optical disc having an information track having a plurality of address information storage portions, the method comprising steps of:
irradiating a laser beam from the optical pickup unit to the optical disc rotating,
scanning the information track by the laser beam according to the tracking error signal generated from the reflected light from the optical disc,
detecting a linear velocity of the optical disc in response to the issuing of the tracking jump command,
acquiring the timing of the tracking jump according to the tracking jump command and the linear velocity,
detecting whether the laser beam has passed the address information storage portion, and
upon detection of the passing, driving the optical pickup by the tracking actuator and executing the tracking jump at the timing.

26. An information reproducing method as claimed in claim 25, the method further comprising steps of:
after execution of the tracking jump, judging whether the laser beam has reached the next address information storage portion, and
if yes, correcting the tracking error signal at the zero-cross point where the laser beam passes the track boundary.

27. An information recording method in the optical disc recording device for recording information onto an optical disc having information track having a plurality of address information storage portions, the method comprising steps of:
irradiating the laser beam from the optical pickup unit onto the optical disc rotating,
scanning the information track by the laser beam according to the tracking error signal generated from the reflected light from the optical disc,
detecting the linear velocity of the optical disc in response to the issuing of the tracking jump command,
acquiring the timing of the tracking jump according to the tracking jump command and the linear velocity,
detecting whether the laser beam has passed the address information storage portion, and
if yes, driving the optical pickup by the tracking actuator so as to execute the tracking jump at the timing.

28. An information recording method as claimed in claim 27, the method further comprising steps of:
after execution of the tracking jump, judging whether the laser beam has reached the next address information recording portion, and
if yes, correcting the tracking error signal at the zero-cross point where the laser beam passes the track boundary.
